(19) United States
(12) Patent Application Publication
(10) Pub. No.: US 2014/0085756 A1
(43) Pub. Date: Mar. 27, 2014

(54) PROTECTION CIRCUIT AND ELECTRONIC DEVICE USING THE SAME

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: CHING-CHUNG LIN, New Taipei (TW); FU-SHAN CUI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/972,976

(22) Filed: Aug. 22, 2013

(30) Foreign Application Priority Data
Sep. 25, 2012 (CN) 2012103598728

(51) Int. Cl. H02H 3/02

(52) U.S. Cl. CPC H02H 3/021
USPC 361/18

(57) ABSTRACT

A protection circuit connected between a power supply and a load comprises an interface unit, a control unit, and a first switching unit. The interface unit is capable of connecting to the load. The control unit generates a variable duty cycle of a pulse width modulation (PWM) signal when the interface unit is connected with the load. The first switching unit is connected between the control unit and the interface unit. The first switching unit switches between a turned-on state and a turned-off state based on the PWM signal.

### BACKGROUND

1. Technical Field

The present disclosure relates to an electronic device with a protection circuit.

2. Description of Related Art

Electronic devices connected with an adapter, such as computers or fridges, include a protection chip. The protection chip is used for preventing elements in the electronic device from being damaged by a surge current generated when the adapter connects with the electronic device. The protection chip is an integrated circuit, which is usually a complicated circuit with a plurality of electronic components. However, a new chip is needed when one of internal electronic components in the chip is damaged.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

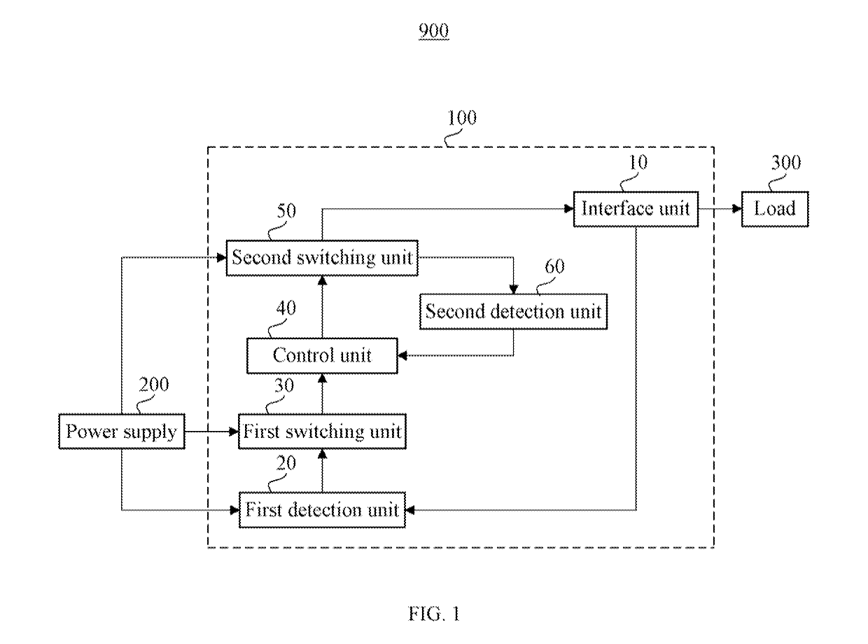

FIG. 1 shows an electronic device 900 of one embodiment of the present disclosure. The electronic device 900 includes a protection circuit 100, a power supply 200 and a load 300. The protection circuit 100 is capable of protecting the load 300 from being damaged by the surge current of the power supply 200. The power supply 200 outputs a working voltage to the load 300. In the embodiment, the power supply 200 is an adapter, and the load 300 is a monitor; the working voltage is 24V or 12V. In other embodiments, the electronic device 900 connects between the power supply 200 and the load 300.

The protection circuit 100 includes an interface unit 10, a first detection unit 20, a first switching unit 30, a control unit 40, a second switching unit 50, and a second detection unit 60.

The interface unit 10 connects to the load 300. In the embodiment, the interface unit 10 plugs into the load 300.

The first detection unit 20 connects between the power supply 200 and the interface unit 10. The first detection unit 20 detects whether the interface unit 10 connects with the load 300. The first detection unit 20 generates a detection signal when the load 300 is inserted into the interface unit 10, and stops generating the detection signal when the load 300 is extracted from the interface unit 10.

The first switching unit 30 connects between the power supply 200 and the control unit 40. The first switching unit 30 turns on to establish a connection between the power supply 200 and the control unit 40 in response to the detection signal, and turns off to cut off the connection between the power supply 200 and the control unit 40 when not receiving the detection signal.

The control unit 40 connects between the first switching unit 30 and the second switching unit 50. The control unit 40 is powered by the working voltage of the power supply 200 when the first switching unit 30 turns on, and generates a pulse width modulation (PWM) signal with a variable duty cycle. The PWM signal includes a first signal and a second signal. In the embodiment, the first signal is a logic high level voltage signal, and the second signal is a logic low level voltage signal.

The second switching unit 50 connects between the power supply 200 and the interface unit 10, and switches between a turned-on state and a turned-off state based on the PWM signal. In the embodiment, the second switching unit 50 turns on based on the first signal, and turns off based on the second signal.

The second detection unit 60 connects between the control unit 40 and the second switching unit 50. The second detection unit 60 detects and outputs the voltage of the second switching unit 50.

The control unit 40 further determines whether the detected voltage is equal to a predetermined voltage. If the detected voltage is equal to the predetermined voltage, the control unit 40 generates a first controlling signal for controlling the second switching unit 50 switch to the turned-on state and remaining in the turned-on state. The predetermined voltage is lower than the working voltage. In the embodiment, the predetermined voltage is 2.5V; the control unit 40 may receives a plurality of voltages in a predetermined time period based on the PWM signal, such as a second, and calculates an average voltage of the received voltages in the predetermined time. The predetermined time can be set to be one second, or two seconds or another time interval by users.

If the detected voltage is lower than the predetermined voltage, the control unit 40 adjusts the duty cycle of the PWM signal based on the detected voltage. The control unit 40 further includes a plurality of threshold voltages which are different from each other and a plurality of predetermined duty cycles which are corresponding to the threshold voltages in a one-to-one relationship. The control unit 40 further compares the detected voltage with the threshold voltages, and generates a corresponding predetermined duty cycle when the detected voltage is equal to one of the threshold voltages. The duty cycle of the PWM signal is increased gradually for increasing the time interval of the first signal, and the voltage of the second switching unit 50 is also increased gradually. In the embodiment, the threshold voltages include 0V, 0.25V, 0.75V, 1V, 1.25V, 1.5V, 1.75V, 2V, 2.25V, and 2.5V. The predetermined duty cycles include 10%, 20%, 30%, 40%, 50%, 60%, 70%, 80%, 90%, and 100%.

Further, when the second switching unit 50 is in the turned-on state and the load 300 is in an abnormal state, the voltage of the second switching unit 50 becomes lower than the predetermined voltage, and the control unit 40 generates a second controlling signal for controlling the second switching unit 50 to be in the turned-off state.

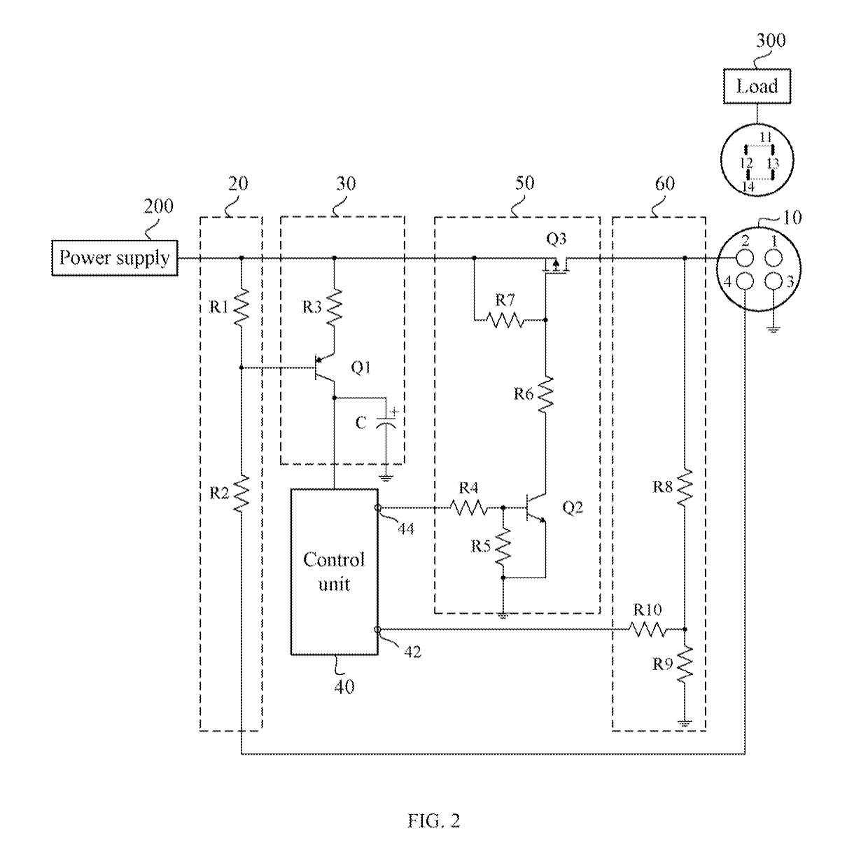

Referring to FIG. 2, the interface unit 10 includes a first socket 1, a second socket 2, a third socket 3, and a fourth socket 4, which are insulated from each other. The second socket 2 connects to the power supply 200 through the second switching unit 50. The third socket 3 is grounded. The fourth socket 4 connects with the first detection unit 20.

The first detection unit 20 includes a first resistor R1 and a second resistor R2. The first resistor R1 and a second resistor R2 connect between the power supply 200 and the fourth socket 4 in series.

The first switching unit 30 includes a first bipolar junction transistor Q1, a limiting resistor R3, and a capacitor C. A base of the first bipolar junction transistor Q1 is connected between the first resistor R1 and the second resistor R2. An emitter of the first bipolar junction transistor Q1 is connected to the power supply 200 through the limiting resistor R3. A collector of the first bipolar junction transistor Q1 is connected to the control unit 40. An anode of the capacitor C is connected to the collector of the first bipolar junction transistor Q1. A cathode of the capacitor C is grounded. In the embodiment, the first bipolar junction transistor Q1 is a pnp type bipolar junction transistor; and the capacitor C is a transient capacitor.

The control unit 40 includes a detection pin 42 and an output pin 44. The output pin 44 outputs the PWM signal.

The second switching unit includes a second bipolar junction transistor Q2, a metal oxide semiconductor field effect transistor (MOSFET) Q3, a first protection resistor R4, a second protection resistor R5, a third resistor R6, and a fourth resistor R7. A base of the second bipolar junction transistor Q2 is connected to the output pin 44 through the first protection resistor R4. An emitter of the second bipolar junction transistor Q2 is grounded. A collector of the bipolar junction transistor Q2 is connected to a gate of the MOSFET Q3 through the third resistor R6. Opposite terminals of the second protection resistor R5 are respectively connected to the base and the emitter of the second bipolar junction transistor Q2. A source of the MOSFET Q3 is connected to the power supply 200. A drain of the MOSFET Q3 is connected to the second socket 2. Opposite terminals of the fourth resistor R7 are respectively connected to the gate and the source of the MOSFET Q3. In the embodiment, the second bipolar junction transistor Q2 is an npn type bipolar junction transistor; the MOSFET Q3 is p-channel enhancement type MOSFET.

The second detection unit 60 includes a first pull-up resistor R8, a second pull-up resistor R9, and a fifth resistor R10. A terminal of the first pull-up resistor R8 is connected between the drain of the MOSFET Q3 and the second socket 2. An opposite terminal of the first pull-up resistor R8 is grounded through the second pull-up resistor R9. A terminal of the fifth resistor R10 is connected between the first pull-up resistor R8 and the second pull-up resistor R9. An opposite terminal of the fifth resistor R10 is connected to the detection pin 42.

The load 300 includes a first plug 11, a second plug 12, a third plug 13, and a fourth plug 14. The first plug 11 is connected to the second plug 12, and the third plug 13 is connected to the fourth plug 14.

The principle of the protection circuit 300 is described, when the interface unit 10 plugs into the load 300, the voltage difference between the base and the emitter of the first transistor Q1 is more than 0.7V, the first transistor Q1 turns on. The control unit 40 is powered on by the power supply 200. Because the MOSFET Q3 turns off, the voltage of the detection pin 42 is 0V, and the duty cycle of the PWM signal output by the output pin 44 is 5%. The second transistor Q2 and the MOSFET Q3 orderly switch between the turned-on state and the turned-off state based on the PWM signal with a 5% duty cycle. The voltage of the detection pin 42 is increased gradually and the duty cycle of the PWM signal is increased gradually. When the voltage of the detection pin 42 is 2.5V, the duty cycle of the PWM signal output by the output pin 44 is 100%, and the second transistor Q2 and the MOSFET Q3 simultaneously be in a turned-on state. As a result, the impact to the load 300 based on the surge current from the power supply 200 is reduced.

The protection circuit 200 switches between the turned-on state and the turned-off state when being plugged with the load 300. Therefore, the impact to the load 300 from the surge current generated by the power supply 200 is reduced.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A protection circuit connected between a power supply and a load, comprising:
an interface unit capable of connecting to the load;
a control unit capable of generating a variable duty cycle of a pulse width modulation (PWM) signal when the interface is connected to the load; and
a first switching unit connected between the control unit and the interface unit, and capable of switching between a turned-on state and a turned-off state based on the PWM signal;
wherein the duty cycle of the PWM signal is increased gradually and the time of the first switching unit being in the turned-on state is increased.

2. The protection circuit of claim 1, wherein the protection circuit further comprises a first detection unit and a second switching unit; the first detection unit is connected between the power supply and the interface unit; the second switching unit is connected between the power supply and the control unit; the first detection unit generates a detection signal to the second switching unit when the interface is connected to the load, and the second switching unit turns on for establishing a connection between the power supply and the control unit, and the control unit powers on.

3. The protection circuit of claim 2, wherein the first detection unit comprises a first resistor and a second resistor; the second switching unit comprises a first transistor; the first resistor and a second resistor is connected between the power supply and the interface unit in series; a base of the first transistor is connected between the first resistor and the second resistor, an emitter of the first transistor is connected to the power supply, a collector of the first transistor is connected to the control unit.

4. The protection circuit of claim 1, wherein the protection circuit further comprises a second detection unit connected between the first switching unit and the control unit; the second detection unit detects the voltage of the second switching unit and outputs a detected voltage to the control unit; the control unit adjusts the duty cycle of the PWM signal based on the detected voltage.

5. The protection circuit of claim 4, wherein the control unit comprises a predetermined voltage; the control unit adjusts duty cycle of the PWM signal based on the comparing result between the detected voltage and the predetermined voltage; when the detected voltage is equal to the predetermined voltage, the control unit generates a first controlling signal for controlling the first switching unit switch to the turned-on state and remaining in the turned-on state.

6. The protection circuit of claim 5, wherein the control unit further comprises a plurality of predetermined duty cycle and a plurality of threshold voltage which are different from each other and a plurality of predetermined duty cycles which corresponds to the threshold voltages in a one-to-one relationship; when the detected voltage is lower than the predetermined voltage, the control unit generates a corresponding predetermined duty cycle when the detected voltage is equal to one of the threshold voltages.

7. The protection circuit of claim 5, wherein when the second switching unit remains on the turned-on state and the load is in an abnormal state to decrease the voltage of the second switching unit, the control unit generates a second controlling signal for controlling the second switching unit to be in the turned-off state based on the voltage detected by the second detection unit.

8. The protection circuit of claim 5, wherein the power supply provides a working voltage to the control unit; the working voltage is more than the predetermined voltage.

9. The protection circuit of claim 1, wherein the PWM signal comprises a first signal and a second signal; the first switching unit switches into the turned-on state in response to the first signal and switches into the turned-off state in response to the second signal; the time interval of the first signal is increased based on the increased the duty cycle of the PWM signal; the voltage of the first switching unit is also increased gradually based on the increased the duty cycle of the PWM signal.

10. The protection circuit of claim 1, wherein the first switching unit comprises a second transistor, a metal oxide semiconductor field effect transistor (MOSFET), a first protection resistor, a second protection resistor, a third resistor, and a fourth resistor; a base of the second transistor is connected to the control unit through the first protection resistor, an emitter of the second transistor is grounded, a collector of the transistor is connected to a gate of the MOSFET through the third resistor; opposite terminals of the second protection resistor are respectively connected to the base and the emitter of the second transistor; a source of the MOSFET is connected to the power supply, a drain of the MOSFET is connected to the interface unit; opposite terminals of the fourth resistor are respectively connected to the gate and the source of the MOSFET.

11. An electronic device connected to a power supply for obtaining a working voltage, comprising:
a load;
an interface unit capable of connecting to the load;
a control unit capable of generating a variable duty cycle of a pulse width modulation (PWM) signal when the interface is connected to the load; and
a first switching unit connected between the control unit and the interface unit, and capable of switching between a turned-on state and a turned-off state based on the PWM signal;
wherein the duty cycle of the PWM signal is increased gradually and the time of the first switching unit being in the turned-on state is increased.

12. The electronic device of claim 11, wherein electronic device further comprises a first detection unit is connected between the power supply and the interface unit; the second switching unit is connected between the power supply and the control unit; the first detection unit generates a detection signal to the second switching unit when the interface is connected to the load, and the second switching unit turns on for establishing a connection between the power supply and the control unit, and the control unit powers on by the working voltage of the power supply.

13. The electronic device of claim 12, wherein the first detection unit comprises a first resistor and a second resistor; the second switching unit comprises a first bipolar junction transistor; the first resistor and a second resistor connect between the power supply and the interface unit in series; a base of the first bipolar junction transistor is connected between the first resistor and the second resistor, an emitter of the first bipolar junction transistor is connected to the power supply, a collector of the first bipolar junction transistor is connected to the control unit.

14. The electronic device of claim 11, wherein the protection circuit further comprises a second detection unit connected between the first switching unit and the control unit; the second detection unit detects the voltage of the second switching unit and outputs to the control unit; the control unit adjusts the duty cycle of the PWM signal based on the detected voltage.

15. The electronic device of claim 14, wherein the control unit comprises a predetermined voltage; the control unit adjusts duty cycle of the PWM signal based on the comparing result between the detected voltage and the predetermined voltage; when the detected voltage is equal to the predetermined voltage, the control unit generates a first controlling signal for controlling the first switching unit switch to the turned-on state and remaining in the turned-on state.

16. The electronic device of claim 15, wherein the control unit further comprises a plurality of predetermined duty cycle and a plurality of threshold voltage which are different from each other and a plurality of predetermined duty cycles which corresponds to the threshold voltages in a one-to-one relationship; when the detected voltage is lower than the predetermined voltage, the control unit generates a corresponding predetermined duty cycle when the detected voltage is equal to one of the threshold voltages.

17. The electronic device of claim 15, wherein when the second switching unit remains on the turned-on state and the load is in an abnormal state to decrease the voltage of the second switching unit, the control unit generates a second controlling signal for controlling the second switching unit to maintain in the turned-off state based on the voltage detected by the second detection unit.

18. The electronic device of claim 15, wherein the working voltage is more than the predetermined voltage.

19. The electronic device of claim 11, wherein the first switching unit comprises a second bipolar junction transistor, a metal oxide semiconductor field effect transistor (MOSFET), a first protection resistor, a second protection resistor, a third resistor, and a fourth resistor; a base of the second bipolar junction transistor is connected to the control unit through the first protection resistor, an emitter of the second bipolar junction transistor is grounded, a collector of the bipolar junction transistor is connected to a gate of the MOSFET through the third resistor; opposite terminals of the second protection resistor are respectively connected to the base and the emitter of the second bipolar junction transistor; a source of the MOSFET is connected to the power supply, a drain of the MOSFET is connected to the interface unit; opposite terminals of the fourth resistor are respectively connected to the gate and the source of the MOSFET.

20. The electronic device of claim 11, wherein the PWM signal comprises a first signal and a second signal; the first switching unit switches into the turned-on state in response to the first signal and switches into the turned-off state in response to the second signal; the time interval of the first signal is increased based on the increased the duty cycle of the PWM signal; the voltage of the first switching unit is also increased gradually based on the increased duty cycle of the PWM signal.
